(19) United States
(12) Patent Application Publication
(10) Pub. No.: US 2026/0039588 A1
(43) Pub. Date: Feb. 5, 2026

(54) METHOD AND SYSTEM FOR EFFICIENT TRAFFIC FORWARDING FROM A PRIVATE CLOUD

(71) Applicant: Nutanix, Inc., San Jose, CA (US)

(72) Inventor: Sragdhara Datta Chaudhuri, Cupertino, CA (US)

(73) Assignee: Nutanix, Inc., San Jose, CA (US)

(21) Appl. No.: 18/790,809

(22) Filed: Jul. 31, 2024

(51) Int. Cl. H04L 45/00; H04L 45/586; H04L 45/745

(52) U.S. Cl. CPC H04L 45/38; H04L 45/586; H04L 45/66; H04L 45/745

(57) ABSTRACT

A host in a private cloud is provided. The private cloud can include one or more hosts running a set of VMs and appear as a logical router to an EGR coupling the private cloud. During operation, the host can receive a first packet from a virtual machine (VM) running on the host. The host can determine that a source media access control (MAC) address of the first packet from the VM includes a virtual MAC address associated with the logical router. The host can replace, based on an address replacement rule programmed at the host, the virtual MAC address with a physical MAC address of a local interface of the host as the source MAC address of the first packet. The host can determine the local interface as an egress interface for forwarding the first packet to the EGR.

### BACKGROUND

### Field

The present disclosure relates to a communication network. More specifically, the present disclosure relates to efficient traffic forwarding to and from a private cloud.

### Related Art

With diverse traffic, virtualization can become progressively more important as a value proposition for distributed systems. In addition, the evolution of virtual computing has made multi-tenancy attractive and, consequently, placed additional requirements on the network. For example, a large number of virtual machines (VMs) can be allocated to a tenant. Therefore, it may be desirable that the network infrastructure can provide a private cloud for hosting the VMs. The private cloud can include a computing environment, such as computing devices operating as hosts for the VMs and a network connecting them, allocated for the tenant.

The private cloud can typically offer computing services to the tenant over a wide-area network (WAN), such as the Internet or an enterprise network. The tenant may not share the resources of the private cloud with another tenant. The same set of physical resources may support one or more private clouds. For example, a host may be provisioned for one or more private clouds. A management device (e.g., a software-defined network (SDN) controller) may provision the physical resources for the private clouds and provide the flow rules. The flow rules allow the hosts of a private cloud to forward traffic to and from the private cloud via an external gateway router (EGR) (e.g., a Top-of-Rack (ToR) switch).

While the flow rules bring many desirable features to traffic forwarding, some issues remain unsolved for forwarding to and from the private cloud.

### SUMMARY

One embodiment of the present invention provides a host in a private cloud. The private cloud can include one or more hosts running a set of VMs and appear as a logical router to an external router outside of the private cloud. During operation, the host can receive a first packet from a virtual machine (VM) running on the host. The host can determine that a source media access control (MAC) address of the first packet from the VM includes a virtual MAC address associated with the logical router. The host can replace, based on an address replacement rule programmed at the host, the virtual MAC address with a physical MAC address of a local interface of the host as the source MAC address of the first packet. The host can determine the local interface as an egress interface for forwarding the first packet to the external router.

In a variation on this embodiment, the local interface of the host can couple the external router and can be associated with the virtual MAC address.

In a variation on this embodiment, the virtual MAC address can be associated with a respective host of the private cloud. The address replacement rule can be programmed on a respective host of the private cloud.

In a variation on this embodiment, the host can generate, at a local instance of the logical router, a layer-2 header for the first packet. The host can then set the virtual MAC address as the source MAC address in the layer-2 header.

In a further variation, the address replacement rule can be programmed outside of the local instance of the logical router at the host.

In a variation on this embodiment, the host can receive a flow rule from a software-defined network (SDN) controller provisioning the private cloud. Here, a respective flow rule can indicate how traffic is to be processed at the host. The host can determine the local interface as an egress interface based on the flow rule.

In a variation on this embodiment, the host can receive, at the local interface from the external router, a second packet based on a direct route for an IP address of the VM. The host can then replace, based on a reverse address replacement rule programmed at the host, the physical MAC address of the local interface with the virtual MAC address as the destination MAC address of the second packet. Subsequently, the host can forward the second packet to the logical router for providing the second packet to the VM.

In a variation on this embodiment, the host can store information indicating a second host that hosts a second VM.

In a further variation, the host can receive a third packet from the external router and determine that the third packet is destined to second VM. The host can then encapsulate the third packet with a tunnel encapsulation header associated with a tunnel between the host and the second host.

Another embodiment of the present invention provides a router coupling a private cloud. During operation, the router can receive a packet destined to a virtual machine (VM) reachable via a logical device. The logical device can correspond to a private cloud comprising one or more hosts running a set of VMs. The router can then look up, in a forwarding data structure, a destination IP address of the packet to a route programmed on the router. Subsequently, the router can determine, from the route, a target IP address associated with the VM. Accordingly, the router can determine a local interface of the router as an egress interface for forwarding the first packet to an external router outside of the private cloud.

In a variation on this embodiment, the route can include a direct route for the destination IP address. The target IP address can then be allocated to a host running a VM associated with the destination IP address.

In a variation on this embodiment, the route can be for a subnet associated with the destination IP address. The target IP address can then be allocated to a host storing information location information of a VM associated with the destination IP address.

### BRIEF DESCRIPTION OF THE FIGURES

FIG. 1A illustrates an exemplary infrastructure that supports efficient traffic forwarding from a private cloud, in accordance with an embodiment of the present application.

FIG. 1B illustrates an exemplary infrastructure that supports efficient traffic forwarding to a private cloud, in accordance with an embodiment of the present application.

FIG. 2A illustrates exemplary efficient traffic forwarding from a private cloud, in accordance with an embodiment of the present application.

FIG. 2B illustrates exemplary efficient traffic forwarding from a private cloud, in accordance with an embodiment of the present application.

FIG. 3A presents a flowchart illustrating a method of a host in a private cloud efficiently forwarding traffic from the private cloud, in accordance with an embodiment of the present application.

FIG. 3B presents a flowchart illustrating a method of an external router coupling a private cloud efficiently forwarding traffic to the private cloud, in accordance with an embodiment of the present application.

FIG. 4 presents a flowchart illustrating a method of a host of a private cloud forwarding external traffic in the private cloud, in accordance with an embodiment of the present application.

FIG. 5 illustrates an exemplary computer system that facilitates efficient traffic forwarding to and from a private cloud, in accordance with an embodiment of the present application.

FIG. 6 illustrates an exemplary apparatus that facilitates efficient traffic forwarding to and from a private cloud, in accordance with an embodiment of the present application.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

Embodiments described herein solve the problem of efficiently forwarding a packet to and from a VM in a private cloud by (i) replacing a cloud media access control (MAC) address allocated to the private cloud with the MAC address of the host of the VM in a packet sent from the VM; and (ii) maintaining a direct route to the host for an Internet Protocol (IP) address of the VM. Typically, to represent the private cloud as a single entity, a single cloud MAC address associated with the private cloud can be the source MAC address of all packets sent from all hosts in the private cloud. Replacing the cloud MAC address with the local MAC address of a host can avoid any disruption to the MAC address learning process at the EGR.

With existing technologies, the EGR can facilitate connectivity to the private cloud. In some examples, the private cloud can be managed by a management device, such as an SDN controller, which can provide the flow rules to the hosts of the private cloud. The flow rules can indicate how traffic from a respective host is to be forwarded. Furthermore, to represent the private cloud as a single entity, the management device can configure a logical device, such as logical router (LR), via which the VMs of the private cloud can be reachable. As a result, packets sent from the VMs can be determined as packets sent from the LR by the EGR.

The LR can be associated with a cloud MAC address, which can be a virtual MAC address. The cloud MAC address can be associated with a logical interface of the LR. The logical interface of the LR can be referred to as the external connectivity interface (ECI). The ECI can operate as a gateway for the private cloud. Since the ECI can be a logical interface on the LR, the ECI can correspond to a physical interface of a host in the private cloud. As a result, traffic to and from the private cloud can be forwarded via the ECI. The host associated with the ECI can be referred to as the external connectivity host (ECH). The cloud MAC address can be associated with the ECI. As a result, when the EGR learns the cloud MAC address, it is learned in association with the ECH (i.e., the physical interface). Accordingly, the VMs of the private cloud can obtain external connectivity via the ECI. The ECH can be dynamically selected. If a current ECH becomes unavailable, another host can assume the role of ECH and can become associated with the cloud MAC address.

When a VM sends packets outside of the private cloud to an external destination, it can be referred to as south-north traffic. For forwarding a packer belonging to the south-north traffic, the host of the VM (e.g., at the hypervisor running the VM on the host) can obtain the packet from the VM. Based on the flow rules, the host can determine the ECH and encapsulate the packet with a tunnel encapsulation header of a tunnel. Subsequently, the host can send the encapsulated packet to ECH via the tunnel. The ECH can receive the encapsulated packet, decapsulate the encapsulation header, and forward the packet via the ECI to the EGR. The layer-2 header of the packet can have the cloud MAC address as the source MAC address. Similarly, when the EGR receives packets destined to the VM from outside of the private cloud, it can be referred to as north-south traffic. For forwarding a packet belonging to the north-south traffic, the EGR can forward the packet to the ECH via the ECI. The ECH can receive the packet via the ECI and forward the packet to the host running the VM via the tunnel.

The tunnel can be established based on a tunneling protocol. Examples of the tunneling protocol can include, but are not limited to, virtual extensible LAN (VXLAN), generic routing encapsulation (GRE), network virtualization using GRE (NVGRE), Generic Network Virtualization Encapsulation (Geneve), layer-2 tunneling protocol (L2TP), multi-protocol label switching (MPLS), and secure socket tunneling protocol (SSTP). Therefore, the encapsulation header can be generated based on the tunneling protocol. For example, if the tunnel is established using the Geneve protocol, the encapsulation header can be a Geneve encapsulation header.

The private cloud may support one or more subnets. A respective VM can be allocated an IP address from a corresponding subnet. For example, if the private cloud includes two subnets for two different departments of the tenant, the VMs of a department can be allocated IP addresses from the subnet associated with the department. The management device may allocate the IP addresses to the VMs. An administrator may manually allocate the IP addresses at the management device. Furthermore, the management device can run a Dynamic Host Configuration Protocol (DHCP) server that can dynamically allocate the IP addresses from corresponding subnets. In some examples, a respective subnet can be associated with a virtual local area network (VLAN). As a result, VMs belonging to a VLAN can be allocated IP addresses from the subnet associated with the VLAN.

The private cloud can also be associated with an external subnet and a corresponding external VLAN for communicating outside of the private cloud. The external VLAN can be associated with an external subnet (e.g., a subnet of public IP addresses). The external VLAN can be represented as an external logical switch (LS) coupled to the ECI of the LR. Since the ECI operates as the external interface of the LR, the ECI can be configured with the VLAN. Hence, the EGR and the ECI can be allocated respective IP addresses from the external subnet. Therefore, the ECH can be associated with the IP address of the ECI. Accordingly, the ECH can send and receive packets from the ECI. To send a packet to the VM via the ECI, the EGR can send an Address Resolution Protocol (ARP) request for the IP address of the ECI. The ECH can send an ARP response comprising the cloud MAC address as a response. Accordingly, the EGR can send the packet to the cloud MAC address.

The external communication, which can include north-south and south-north traffic forwarding, from the private cloud may include an additional internal hop among the hosts within the private cloud. In particular, other hosts can send packets from local VMs to the ECH for external communication. Such packets are sent over respective tunnels. As a result, the hosts need to perform encapsulation and decapsulation operations on the packets, which can be resource intensive and inefficient. The external communication to and from the VMs of the private cloud can be forwarded through the ECH. Forwarding traffic through a single ECH can limit the cumulative throughput. Furthermore, if the ECH becomes unavailable, switching over to another ECH can incur a delay. During this period, the north-south and south-north traffic may be dropped.

To solve this problem, the ECI can be associated with each of the hosts of the private cloud to reduce the reliance on the ECH for external communication. Consequently, a respective host can forward packets to the EGR with the cloud MAC address as a source MAC address. However, if different hosts send packets to the EGR, the cloud MAC address can be repeatedly learned from multiple hosts, which can cause traffic disruption and instability at the EGR.

To avoid the repeated learning of the cloud MAC address, a respective host of the private cloud can be configured with an address replacement rule. The rule can indicate that, for a respective packet destined to outside of the private cloud, the host is to replace the cloud MAC address with the local MAC address of a local physical interface of the host as the source MAC address of the packet. Here, the local interface can be coupled to the EGR and operate as the ECI. Accordingly, the host can replace the cloud MAC address with the physical MAC address of the local interface as the source MAC address of the packet. Subsequently, the host can forward the packet to the EGR. Forwarding the packet can include determining the local interface as the egress interface for the packet.

As a result, instead of learning the cloud MAC address, the EGR can learn the local MAC address of the hosts. Consequently, the EGR may not learn the same MAC address from multiple interfaces. Hence, each host of the private cloud can send external packets from the local VMs (e.g., VMs running on the host) to the EGR without using inter-host communication within the ECH via a corresponding tunnel. Furthermore, the rule can be configured outside of the configurations provided by the management device. Therefore, the current management device can continue to operate without modifications. In this way, the private cloud can support efficient external traffic forwarding.

Moreover, the EGR can be configured with a set of direct routes. A respective direct route in the set can correspond to the IP address of a VM. A direct route typically provides routing for an IP address in its entirety instead of a subnet. The direct route can indicate that if the IP address of the VM is the destination address of a packet, the EGR is to forward the packet to the IP address of the VM's host. For example, if the IP address of the VM is A.B.C.D, the direct route is expressed as A.B.C.D/32. In contrast, a subnet can correspond to a range of IP addresses (e.g., A.B.C.0/24).

If the IP address of the local physical of the VM's host is W.X.Y.Z, the target IP address of the direct route can be W.X.Y.Z. The target IP address can be the IP address to which a packet matching the direct route is to be forwarded. Hence, the direct route for the VM can indicate A.B.C.D→W.X.Y.Z. As a result, when a packet destined to a VM is received at the EGR, it can send an ARP request for the IP address of the ECI of the corresponding host. The host can then send an ARP response comprising the MAC address of the local interface of the host. Subsequently, the EGR can forward the packet to the host of the VM. The host can receive the packet at the local interface from the EGR. The host can then replace, based on a reverse address replacement rule programmed at the host, the MAC address of the local interface with the cloud MAC address as the destination MAC address of the packet. Subsequently, the host can forward the packet to the VM via the logical topology of the private cloud. For example, the host can forward the packet to the LR (e.g., based on the cloud MAC address). The LR can then forward the packet to the VM through the LS associated with the subnet of the VM.

If the EGR's forwarding hardware has limited resources, such as limited space in its Ternary Content Addressable Memory (TCAM), programming the entire set of direct routes may not be suitable for the EGR. Under such circumstances, one of the hosts can be tasked with the forwarding of the north-south traffic to the destination host. This host can be referred to as a distributing host. The distributing host can maintain a mapping indicating which VM is executed on which host. The EGR can then include a route directed to the distributing host. The route can include the subnet of the IP addresses of the private cloud. For example, if the subnet is A.B.0.0/16 and the IP address of the distributing host is W.X.Y.Z, the route can indicate A.B.0.0/16→W.X.Y.Z. Accordingly, the EGR can forward packets destined to a VM to the distributing host. Based on the mapping, the distributing host can determine the host executing the VM. The distributing host can then locally forward the packet to the VM or forward the packet to the VM's host via a corresponding tunnel.

Instead of using a single host for distributing north-south traffic in the private cloud, a plurality of hosts (e.g., all hosts or a subset of hosts) of the private cloud can distribute north-south traffic in the private cloud. In some examples, a respective host of the private cloud can operate as a distributing host and, hence, can maintain the mapping indicating which VM is executed on which host. A distribution function can be applied to the IP address of a VM to select the host that can store the direct route of the IP address. Examples of the distribution function can include, but are not limited to, a hash function, a load balancer, and a round-robin function. When a load balancer is used as a distribution function, applying the distribution function may include forwarding the packet to the load balancer. For example, if the IP address of the load balancer is C.D.E.F, the distribution function at the EGR may be represented as a route indicating A.B.0.0/16→C.D.E.F. Based on the distribution function, traffic to the private cloud can be distributed among the hosts. When the EGR receives a packet destined to a VM, the EGR can apply the distribution function to the destination IP address of the packet and select a host. The EGR can then forward the packet to the selected host. Based on the mapping, the host can locally forward the packet to the VM or forward the packet to the VM's host via a corresponding tunnel. It should be noted that the address replacement rule and the reverse address replacement rule can also be applicable to containers in the private cloud communicating with entities outside the private cloud.

In this disclosure, the term “packet” refers to a group of bits that can be transported together across a network. “Packet” should not be interpreted as limiting embodiments of the present invention to any networking layer. “Packet” can be replaced by other terminologies referring to a group of bits, such as “message,” “frame,” “cell,” or “datagram.”

The term “switch” is used in a generic sense, and it can refer to any standalone or fabric switch operating in any network layer. “Switch” should not be interpreted as limiting embodiments of the present invention to layer-2 networks. Any physical or virtual device (e.g., a virtual machine, which can be a virtual switch, operating on a computing device) that can forward traffic to an end device can be referred to as a “switch.” Examples of such a device include, but not limited to, a layer-2 switch, a layer-3 router, or a TRILL RBridge.

### Network Architecture

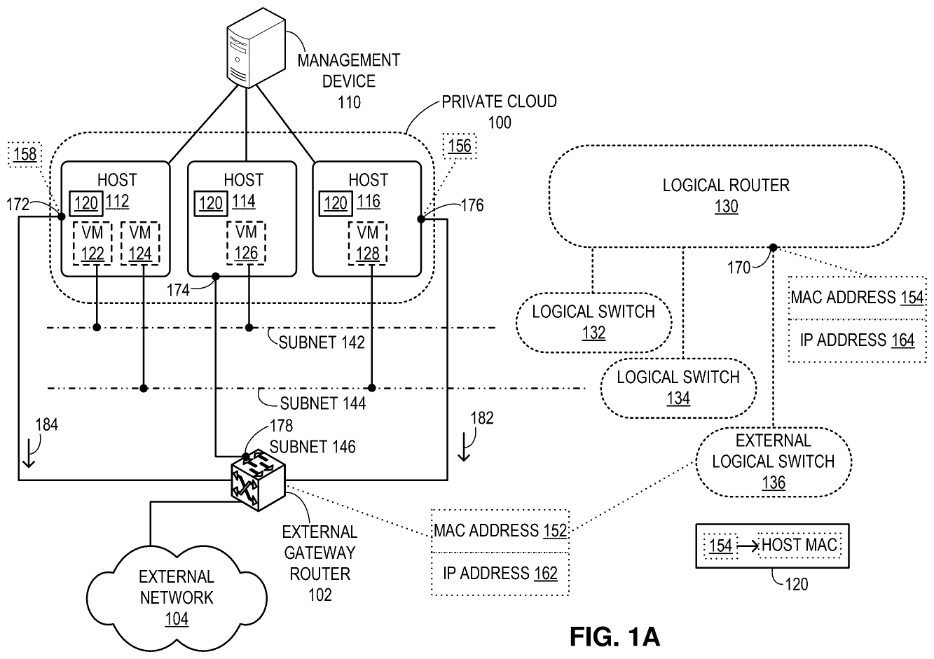

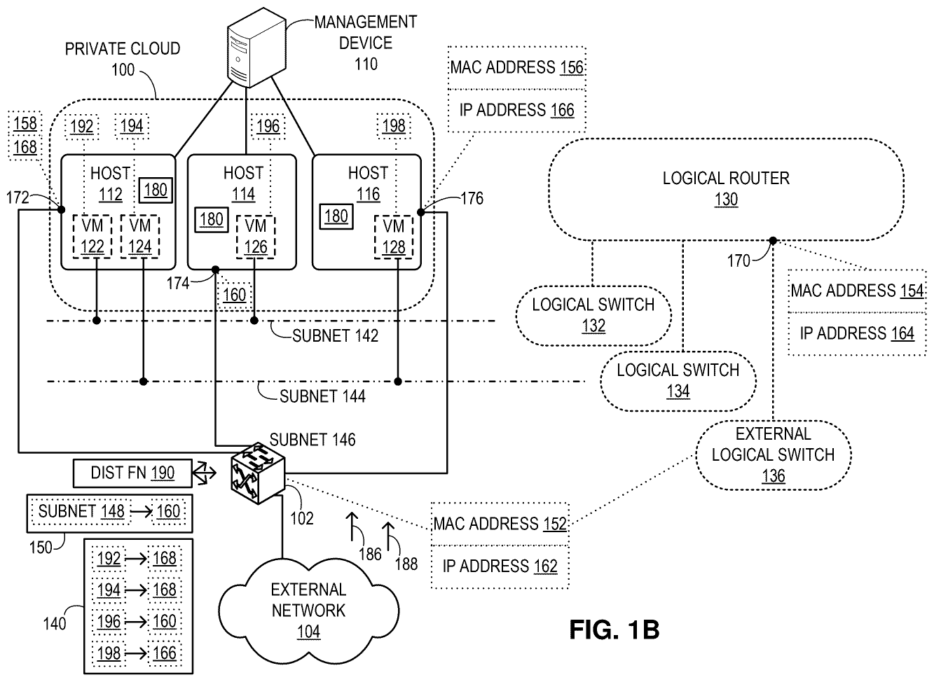

FIG. 1A illustrates an exemplary infrastructure that supports efficient traffic forwarding from a private cloud, in accordance with an embodiment of the present application. As illustrated in FIG. 1A, a private cloud 100 can include a number of hosts 112, 114, and 116. Here, a respective host can be a computer system with at least a processor and a memory. Private cloud 100 can also include a network that couples hosts 112, 114, and 116 to each other (not shown in FIG. 1A). In some embodiments, private cloud 100 can be a virtual private cloud (VPC), which can be formed with virtualized resources of a physical infrastructure. In some examples, private cloud 100 may be deployed over a public cloud. Private cloud 100 may offer computing services to a tenant accessible over an external network 104. Here, network 104 can be a WAN, such as the Internet or an enterprise network. A management device 110 (e.g., an SDN controller) may provision the resources for the private cloud 100 and provide a set of flow rules. These flow rules can allow hosts 112, 114, and 116 to forward traffic between the VMs in the subnets of private cloud 100 and external network 104 via an EGR 102 (e.g., a ToR switch). Similarly, the flow rules can dictate inter-VM traffic forwarding within private cloud 100 (e.g., the east-west traffic within private cloud 100 without involving EGR 102).

VMs 122 and 124 can execute on host 112, VM 126 can execute on host 114, and VM 128 can execute on host 116. Currently, management device 110 can represent private cloud 100 as a logical device, such as an LR 130. As a result, packets sent from VMs 122, 124, 126, and 128 can be determined as packets sent from LR 130 by EGR 102. EGR 102 can be represented as an external logical switch (LS) 136 coupled to LR. An interface 170 of LR 130 can couple LR 130 to external LS 136. Therefore, interface 170 can be the ECI in private cloud 100. ECI 170 can be associated with a cloud MAC address 154 facilitating external communication for private cloud 100. MAC address 154 can be a virtual MAC address.

Since ECI 170 can be a virtual interface on LR 130, ECI 170 can correspond to a physical interface of a host in private cloud 100. Suppose that interface 174 of host 114 is the physical interface. Interface 174 can couple an interface 178 of EGR 102 for facilitating the external communication (e.g., the north-south and south-north traffic forwarding) for private cloud 100. Accordingly, ECI 170 can be associated with host 114, which can operate as an ECH for private cloud 100. Therefore, MAC address 154 of ECI 170 can be associated with host 114. As a result, when EGR 102 learns MAC address 154, it is learned in association with interface 174.

When VM 128 sends a packet 182 to an external destination (e.g., reachable via network 104), host 116 (e.g., at the hypervisor running VM 128 on host 116) can obtain packet 182. Based on the flow rules, host 116 can determine that host 114 as the ECH and encapsulate packet 182 with a tunnel encapsulation header of a tunnel. Subsequently, host 116 can send encapsulated packet 182 to host 114 via the tunnel. Host 114 can receive encapsulated packet 182, decapsulate the encapsulation header, and forward packet 182 via ECI 170 to EGR 102. Similarly, when EGR 102 receives a packet destined to VM 128, EGR 102 can forward the packet to host 114. Host 114 can receive the packet at its local interface 174 and forward the packet to host 116 via the tunnel. The tunnel can be established based on a tunneling protocol. Examples of the tunneling protocol can include, but are not limited to, VXLAN, GRE, NVGRE, Geneve, L2TP, MPLS, and SSTP.

Private cloud 100 may support a number of subnets 142 and 144. VMs 122 and 126 can be allocated respective IP addresses from subnet 142, and VMs 124 and 128 can be allocated respective IP addresses from subnet 144. Subnets 142 and 144 can be represented as LS 132 and LS 134, respectively. Therefore, VMs 122 and 126 can be logically coupled to LS 132, which can then be logically coupled to LR 130. Similarly, VMs 124 and 128 can be logically coupled to LS 134, which can also be logically coupled to LR 130. In this way, VMs 122, 124, 126, and 128 can be coupled to LR 130.

Management device 110 may allocate the IP addresses to VMs 122, 124, 126, and 128. An administrator may manually allocate the IP addresses at management device 110. Furthermore, the IP addresses can be allocated to the corresponding VMs from a DHCP server that can dynamically allocate the IP addresses from corresponding subnets 142 and 144. In some examples, subnets 142 and 144 can be associated with corresponding VLANs. As a result, VMs belonging to a VLAN can be allocated IP addresses from the subnet associated with the VLAN. Subnets 142 and 144 may be overlay subnets that do not involve a VLAN.

Private cloud 100 can also be associated with an external subnet 146 and a corresponding external VLAN for communicating outside of LR 130. Since ECI 170 can operate as a gateway interface of LR 130, ECI 170 and interface 178 of EGR 102 can be configured with the VLAN. In this example, ECI 170 can be allocated IP address 164 from subnet 146. Furthermore, a gateway IP address 162 can be associated with EGR 102. Accordingly, host 114 can send and receive packets via interface 174.

To send a packet to VM 128 via LR 130, EGR 102 can send an ARP request for IP address 164. Since host 114 is associated with ECI 170, host 114 can send an ARP response comprising MAC address 154 as a response. EGR 102 can then learn MAC 154 and may associate it with interface 178 in its layer-2 forwarding table. Accordingly, EGR 102 can add a layer-2 header to the packet. The layer-2 header can include MAC address 154 as the destination address and MAC address 152 of EGR 102 as the source address. EGR 102 can then send the packet to host 114 based on the layer-2 header.

Currently, the communication between private cloud 100 and EGR 102 can include an additional hop to host 114 within private cloud 100. In particular, to send packets to EGR 102, hosts 112 and 116 can send the packets to host 114 over respective tunnels. As a result, hosts 112 and 116 can encapsulate and decapsulate tunnel headers on the packets, which can be resource-intensive operations. Furthermore, forwarding traffic through a single host 114 can limit the cumulative throughput. Furthermore, if host 114 becomes unavailable, switching over to another ECH (e.g., host 112 or 116) can incur a delay. During this period, the north-south and south-north traffic may be dropped.

To solve this problem, MAC address 154 can further be associated with hosts 112 and 116. In other words, ECI 170 can be associated with hosts 112, 114, and 116. Management device 110 can configure hosts 112, 114, and 116 to represent interface 170 and associate MAC address 154 with these hosts. In this example, hosts 112, 114, and 116 can couple EGR 102 via interfaces 172, 174, and 176, respectively. Since MAC address 154 can be associated with hosts 112, 114, and 116, each of interfaces 172, 174, and 176 may send packets from private cloud 100 to EGR 102. Consequently, EGR 102 can repeatedly learn MAC address 154 from hosts 112, 114, and 116, which can cause traffic disruption and instability at EGR 102.

To avoid the repeated learning of the cloud MAC address, hosts 112, 114, and 116 can be configured with an address replacement rule 120 (e.g., an ACL rule). Rule 120 can indicate that, for a respective packet with MAC address 154 as the source MAC address, MAC address 154 should be replaced by the local MAC address of the host. For example, when VM 128 sends packet 182, host 116 can obtain packet 182 based on the configuration provided by management device 110. Management device 110 can provide a flow rule indicating that, to send a packet outside of private cloud 100, host 116 is to forward the packet via ECI 170 of LR 130. Accordingly, host 116 can encapsulate packet 182 with a layer-2 header. Host 116 can set MAC addresses 152 and 154 as the destination and source addresses of the layer-2 header.

Similarly, management device 110 can provide a flow rule indicating that, to send a packet outside of private cloud 100, host 112 is to forward the packet via interface 170 of LR 130. Hence, when VM 122 sends packet 184, host 112 can obtain packet 184 based on the configuration provided by management device 110. Accordingly, host 112 can update the layer-2 header to packet 184. Host 112 can set MAC addresses 152 and 154 as the destination and source addresses of the layer-2 header.

For packet 182, host 116 can replace MAC address 154 with MAC address 156 of interface 176 in the layer-2 header of packet 182 based on rule 120. Subsequently, host 116 can send packet 182 to EGR 102 with MAC address 156 as the source MAC address. Here, sending packet 182 to EGR 102 can include determining interface 176 as the egress interface for packet 182. Similarly, for packet 184, host 112 can replace MAC address 154 with MAC address 158 of interface 172 in the layer-2 header of packet 184 based on rule 120. Subsequently, host 112 can send packet 184 to EGR 102 with MAC address 158 as the source MAC address. Sending packet 184 to EGR 102 can include determining interface 172 as the egress interface for packet 184. As a result, instead of learning MAC address 154 from interfaces 172 and 176, EGR 102 can learn MAC addresses 158 and 156, respectively, from interfaces 172 and 176.

In this way, interface 170 and its MAC address 154 can be associated with hosts 112, 114, and 116, which allows a respective host of private cloud 170 to send packets from locally hosted VMs to EGR 102 while bypassing inter-host forwarding over a tunnel. Furthermore, rule 120 can be configured outside of the flow rules provided by management device 110. Consequently, even when hosts 112, 114, and 116 initially use MAC address 154 as the source MAC address based on the flow rules from management device 110, rule 120 can change MAC address 154 with the MAC address of the local host. Therefore, management device 110 can continue to operate without modifications, while rule 120 can allow efficient external traffic forwarding from private cloud 100.

FIG. 1B illustrates an exemplary infrastructure that supports efficient traffic forwarding to a private cloud, in accordance with an embodiment of the present application. To efficiently forward traffic from network 104 to hosts 112, 114, and 116, EGR 102 can be configured with a set of direct routes 140. Direct routes 140 can be stored in a forwarding data structure, such as a forwarding information base (FIB) of EGR 102. In some examples, the forwarding data structure can be stored in the forwarding hardware (e.g., in a TCAM) of EGR 102. Suppose that VMs 122, 124, 126, and 128 are associated with IP addresses 192, 194, 196, and 198, respectively. Here, IP addresses 192 and 196 can be in subnet 142, and IP addresses 194 and 198 can be in subnet 144. In addition, interfaces 172, 174, and 176 can be associated with IP addresses 168, 160, and 166, respectively.

A direct route for an IP address of the VM can indicate that if the IP address is the destination address of a packet, EGR 102 is to forward the packet to the IP address, which can be the target IP address, of the corresponding host. For example, a direct route associated with VM 122 can indicate that packets destined to IP address 192 are to be forwarded to IP address 168. As a result, when a packet 186 destined to VM 122 is received at EGR 102, it can send an ARP request for IP address 168. Host 112 can receive the ARP request and send an ARP response comprising MAC address 158 of interface 172.

EGR 102 can then forward packet 186 to host 112 based on MAC address 158. Another direct route associated with VM 128 can indicate that packets destined to IP address 198 are to be forwarded to IP address 166. Upon receiving a packet 188 destined to VM 128, EGR 102 can send an ARP request for IP address 166. Host 116 can receive the ARP request and send an ARP response comprising MAC address 156 of interface 176. EGR 102 can then forward packet 188 to host 116 based on MAC address 156.

If the forwarding hardware of EGR 102 has limited resources, such as a limited number of TCAM entries, programming direct routes 140 on EGR 102 may be infeasible. One of hosts 112, 114, and 116 can be tasked with the forwarding of the north-south traffic to the destination hosts. In this example, host 114 can be selected as a distributing host that can distribute north-south traffic in private cloud 110. Host 114 can maintain a mapping 180 in the memory of host 114. Mapping 180 can indicate which VM of private cloud 100 is executed on which host. Mapping 180 can be provided to host 114 from management device 110.

EGR 102 can include a route 150 to host 114. Route 150 can indicate that if the destination address of a packet matches a subnet 148, which can be the subnet of private cloud 100, the packet should be forwarded to IP address 160. Here, subnet 148 can encompass subnets 142 and 144. Accordingly, EGR 102 can forward a packet destined to a VM to host 114. Upon receiving the packet via interface 174, host 114 can replace the destination MAC address with MAC address 154 and forward the packet based on its destination based on mapping 180. If the packet is destined to VM 126, host 114 can locally provide the packet to VM 126. Otherwise, the host can forward the packet to the VM's host via a corresponding tunnel.

Instead of a single host 114 forwarding north-south traffic in private cloud 100, a respective of hosts 112, 114, and 116 can be selected as a distributing host. Under such circumstances, mapping 180 can be maintained in hosts 112, 114, and 116, When EGR 102 receives a packet destined to a VM, EGR 102 can apply a distribution function 190 to the destination IP address of the packet to select a corresponding distributing host. Examples of distribution function 190 can include, but are not limited to, a hash function, a load balancer, and a round-robin function. When a load balancer is used as a distribution function, EGR 102 applying the distribution function may include forwarding the packet to the load balancer. The load balancer can then select the host. As a result, north-south traffic to private cloud 100 can be distributed among hosts 112, 114, and 116. EGR 102 can then forward the packet to the selected host.

Suppose that EGR 102 applies distribution function 190 to the destination address of a packet to determine that the direct route is stored in host 114. Accordingly, EGR 102 can forward the packet to host 114. Upon receiving the packet via interface 174, host 114 can forward the packet based on its destination. If the packet is destined to VM 126, host 114 can locally provide the packet to VM 126. Otherwise, the host can forward the packet to the VM's host via a corresponding tunnel.

Forwarding to and from a Private Cloud

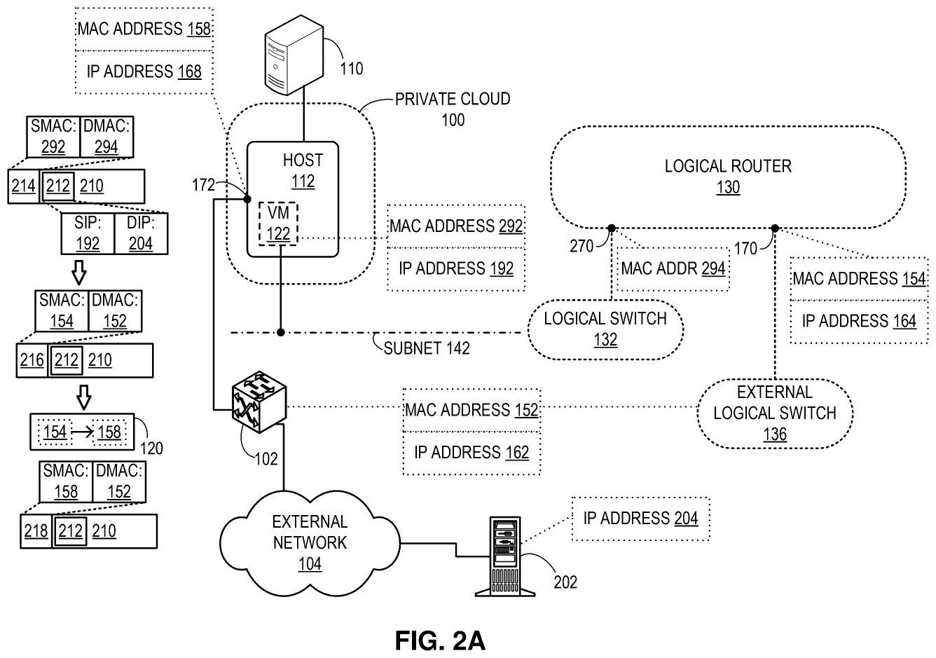

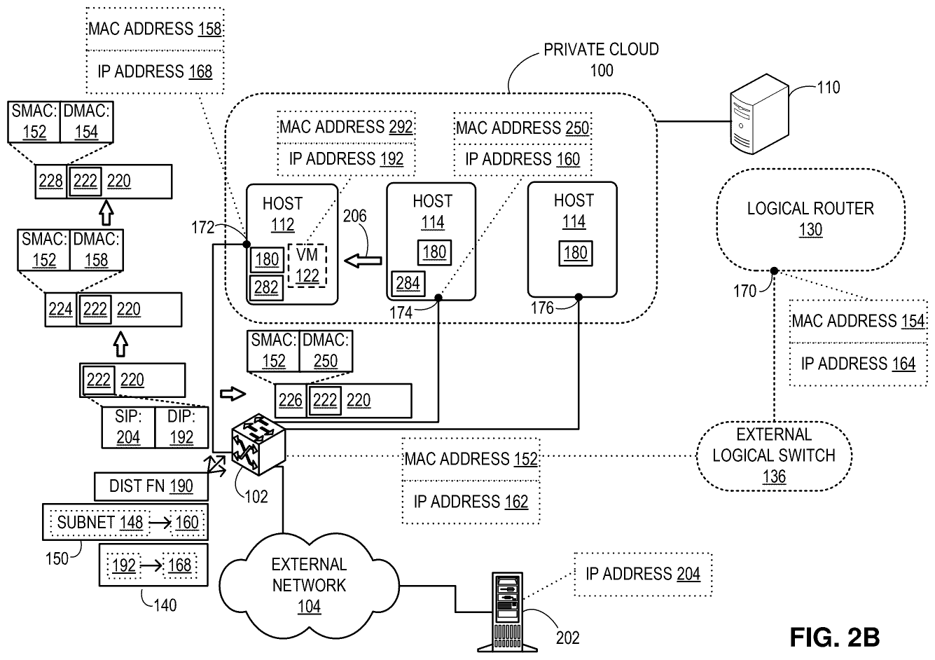

FIG. 2A illustrates exemplary efficient traffic forwarding from a private cloud, in accordance with an embodiment of the present application. Suppose that VM 122 is associated with a MAC address 292. VM 122 can send a packet 210 to an external destination, such as end device 202. End device 202 can be a user device or a server (e.g., a web server hosting a web service). End device 202 can be associated with IP address 204. Packet 210 can be a layer-3 packet with a layer-3 header 212 (e.g., an IP packet with an IP header). IP address 192 of VM 122 and IP address 204 of end device 202 can be the source and destination IP addresses of header 212.

In this example, VM 122 can be coupled to LR 130 via LS 132 corresponding to subnet 142 of VM 122. LR 130's logical interface 270, which can be associated with MAC address 294 (e.g. a virtual MAC address), can couple LS 132. For forwarding packet 210, VM 122 can obtain MAC address 294 (e.g., based on a configuration from management device 110). VM 122 can then add a layer-2 header 214 (e.g., an Ethernet header) to packet 210. MAC address 292 of VM 122, and MAC address 294 of interface 270 can be the source and destination MAC addresses of header 214.

When VM 122 sends packet 210, host 112 can obtain packet 210. Host 112 can then remove header 214 and add another layer-2 header 216 to packet 210 for the next hop. Since packet 210 is to be sent outside of private cloud 100, host 112 can send packet 210 from virtual interface 170 of LR 130. Therefore, MAC address 154 of interface 170 can be the source MAC address of header 216. To send packet 210 to EGR 102, host 112 can set MAC address 152 as the destination MAC address of header 216.

Rule 120 can indicate that, for a respective packet with MAC address 154 as a source address, MAC address 154 should be replaced by local MAC address 158 of interface 172. Accordingly, host 112 can replace MAC address 154 with MAC address 158 of interface 172, thereby modifying header 216 to generate a new layer-2 header 218. Subsequently, host 112 can send packet 210 to EGR 102 with MAC address 158 as the source MAC address. As a result, instead of learning MAC address 154 from packet 210, EGR 102 can learn MAC address 158 from packet 210.

FIG. 2B illustrates exemplary efficient traffic forwarding from a private cloud, in accordance with an embodiment of the present application. If end device 202 sends a packet 220 to VM 122, layer-3 header 222 of packet 220 can include IP address 204 of end device 202 and IP address 192 of VM 122 as the source and destination IP addresses. When EGR 102 receives packet 220, EGR 102 can look up IP address 192 in direct routes 140 and determine next-hop IP address 168 of host 112. EGR 102 can then send an ARP request for IP address 168 and receive corresponding MAC address 158 as an ARP response from host 112. EGR 102 can then add a layer-2 header 224 to packet 220. MAC address 152 of EGR 102 and MAC address 158 of interface 172 can be the source and destination MAC addresses of header 224. EGR 102 can then send packet 220 to interface 172 of host 112, which can maintain a reverse replacement rule 282. Rule 282 can indicate that if the destination MAC address is MAC address 158 and the destination IP belongs in subnet 148, the destination MAC address is to be changed to MAC address 154. Host 112 can then update layer-2 header 224 of packet 220 to generate a new layer-2 header with MAC address 154 as the destination MAC address. Host 112 can then forward packet 220 to LR 130 for providing packet 220 to VM 122.

However, if direct routes 140 are not programmed in EGR 102, host 114 can be selected as the distributing host. EGR 102 can then include route 150 indicating that if the destination address of a packet matches subnet 148, the packet should be forwarded to IP address 160 of interface 174. Accordingly, EGR 102 can send an ARP request for IP address 160 and receive corresponding MAC address 250 of interface 174 from host 114. EGR 102 can then add a layer-2 header 226 to packet 220. MAC address 152 of EGR 102 and MAC address 250 of interface 174 can be the source and destination MAC addresses of header 226. EGR 102 can then send packet 220 to interface 174 of host 114.

Host 114 can then determine, based on mapping 180, that destination VM 122 is on host 112, and hence, packet 220 should be forwarded to host 112. Host 114 can then encapsulate packet 220 with a tunnel encapsulation header and send encapsulated packet 220 via tunnel 206 to host 112. The source and destination addresses of the encapsulation header can be IP addresses 160 and 168, respectively. Host 112 can receive the encapsulated packet, decapsulate the encapsulation header, and obtain packet 220. Host 114 can maintain a reverse replacement rule 284. Rule 284 can indicate that if the destination MAC address is MAC address 250 and the destination IP belongs in subnet 148, the destination MAC address is to be changed to MAC address 254. Host 112 can then update layer-2 header 226 of packet 220 and generate a new layer-2 header with MAC address 154 as the destination MAC address. Host 112 can then forward packet 220 to LR 130 for providing packet 220 to VM 122.

Instead of a single host 114 forwarding north-south traffic in private cloud 100, a respective of hosts 112, 114, and 116 can be selected as a distributing host. Under such circumstances, mapping 180 can be maintained in hosts 112, 114, and 116. When EGR 102 receives packet 220, EGR 102 can apply distribution function 190 to destination IP address 192 of packet 220 to select a corresponding distributing host 114. When a load balancer is used as a distribution function, EGR 102 applying the distribution function may include forwarding the packet to the load balancer. Accordingly, EGR 102 can forward packet 220 to host 114. Upon receiving packet 220 via interface 174, host 114 can forward packet 220 based on its destination. Since a respective host of private cloud 100 operates as a distributing host, if a host becomes unavailable, other hosts can continue to operate as distributing hosts.

### Operations

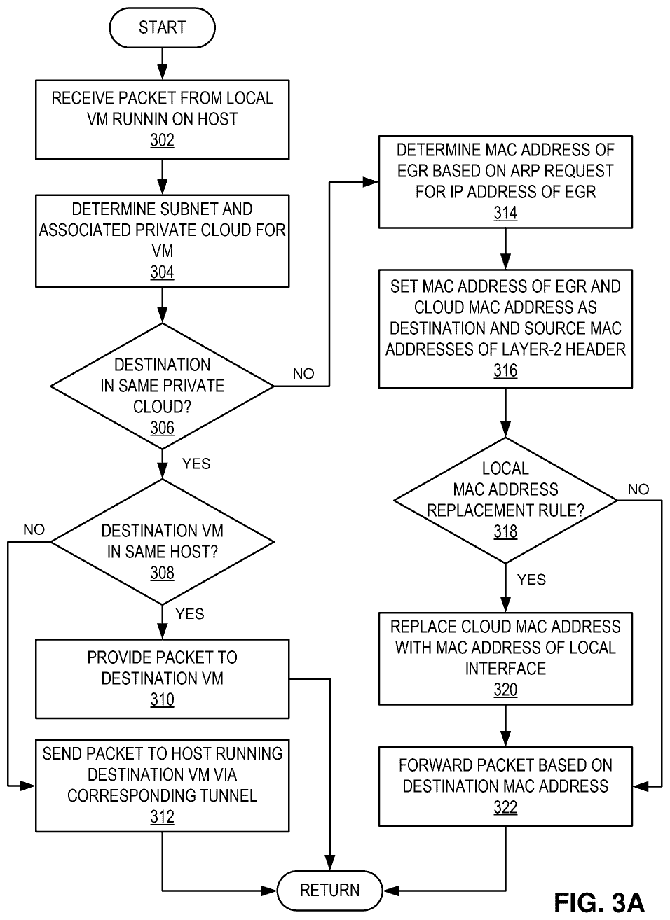

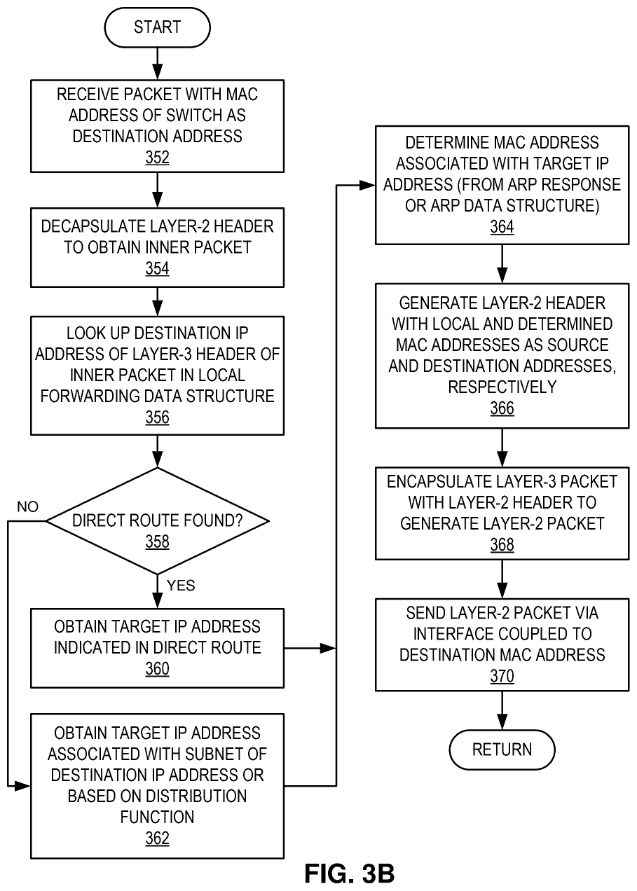

FIG. 3A presents a flowchart illustrating a method of a host in a private cloud efficiently forwarding traffic from the private cloud, in accordance with an embodiment of the present application. During operation, the host can receive a packet from a local VM running on the host (operation 302). In some embodiments, the host can run a hypervisor executing the VM. In the example in FIG. 2A, host 112 can receive a packet 210 from VM 122. The host may receive the packet at the virtual switch of the hypervisor. A management device, such as an SDN controller, can provision the host with flow rules based on which the host can receive and process the packet. The host can determine the subnet and associated private cloud for the VM (operation 304). The host can then determine whether the destination of the packet is in the same private cloud (operation 306).

If the destination is in the same private cloud, the host can determine whether the destination VM is in the same host (operation 308) (i.e., the destination VM runs on the local host). If the destination VM is in the same host, the host can provide the packet to the destination VM (operation 310). On the other hand, the host can send the packet to the host running the destination VM via a corresponding tunnel (operation 312). If the destination is not in the same private cloud, the host can determine the EGR's MAC address of the EGR based on an ARP request for the IP address of the EGR (operation 314). Here, the MAC address of the EGR can be obtained from the ARP response from the EGR. The host can then set the MAC address of the EGR and the cloud MAC addresses as the destination and source MAC addresses of the layer-2 header of the packet (operation 316).

The host can then determine whether there is a local MAC address replacement rule (operation 318). The rule can indicate that if a cloud MAC address (e.g., a virtual MAC address, such as MAC address 154 of FIG. 2A) of the private cloud is the source MAC address of a packet, it is to be replaced by the MAC address of a local interface of the host. The local interface can be coupled to an EGR and can be associated with the cloud MAC address. If there is a local MAC address replacement rule, the host can replace the cloud MAC address with the MAC address (e.g., a physical MAC address) of the local interface (operation 320). If there is not a local MAC address replacement rule (operation 318) or upon replacing the cloud MAC address (operation 320), the host can forward the packet based on the destination MAC address (operation 322).

FIG. 3B presents a flowchart illustrating a method of an external router coupling a private cloud efficiently forwarding traffic to the private cloud, in accordance with an embodiment of the present application. During operation, the external router, which can be an EGR coupling the private cloud, can receive a packet with the MAC address of the EGR as a destination address (operation 352). Since the destination address matches the local address, the EGR can decapsulate the layer-2 header to obtain the inner packet (operation 354). The switch can then look up the destination IP address of the layer-3 header of the inner packet in the local forwarding data structure (operation 356). In the example in FIG. 2B, EGR 102 can receive a packet 220 and determine destination IP address 192 in layer-3 header 222.

The EGR can then determine whether a direct route is found for the destination IP address (operation 358). If a direct route is found, the EGR can obtain a target IP address indicated in the direct route (operation 360). The target IP address can be the IP address to which a packet matching the direct route is to be forwarded. On the other hand, if a direct route is not found, the EGR can obtain the target IP address associated with the subnet of the destination IP address or based on the distribution function (operation 362). The EGR can perform the longest-prefix match in the forwarding data structure for the destination IP address to determine the subnet.

Upon obtaining the target IP address (operation 360 or 362), the EGR can determine the MAC address associated with the target IP address (operation 364). The EGR can obtain the MAC address from an ARP response for the target IP address or an ARP data structure (e.g., an ARP table) storing the ARP resolution for the target IP address. The EGR can then generate a layer-2 header with the local and determined MAC addresses as the source and destination addresses, respectively (operation 366). The EGR can then encapsulate the layer-3 packet with the layer-2 header to generate a layer-2 packet (operation 368). Subsequently, the EGR can send the layer-2 packet via the interface (e.g., an egress interface) coupled to the destination MAC address (operation 370).

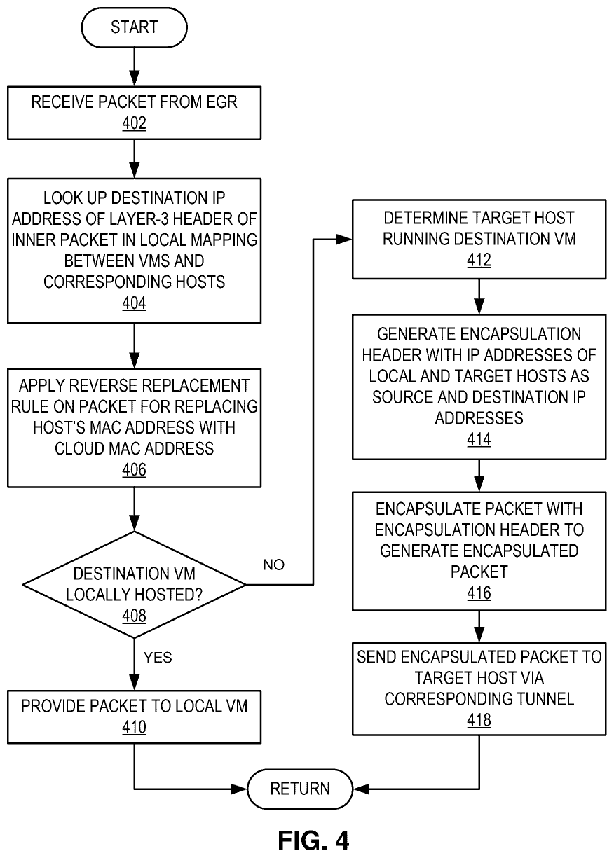

FIG. 4 presents a flowchart illustrating a method of a host of a private cloud forwarding external traffic in the private cloud, in accordance with an embodiment of the present application. During operation, the host can receive a packet from an EGR (operation 402). The host can then look up the destination IP address of the layer-3 header of the inner packet in the local mapping between VMs of the private cloud and their corresponding hosts (operation 404). In the example in FIG. 2B, host 112 can receive a packet 220 and determine destination IP address 192 in layer-3 header 222. The host can then apply a reverse replacement rule (e.g., rule 282 in FIG. 2B) on the packet for replacing the host's MAC address (i.e., the MAC address of the physical interface corresponding to the ECI) with the cloud MAC address (operation 406).

The host can then determine whether the destination VM, as indicated by the destination IP address, is locally hosted (i.e., executes on the host) (operation 408). If the destination VM is locally hosted, the host can provide the packet to the local VM (operation 410). For example, host 112 can provide packet 220 to local VM 112. On the other hand, if the destination VM is not locally hosted, the host can determine the target host running the destination VM (operation 412). Subsequently, the host can generate a tunnel encapsulation header with the IP addresses of local and target hosts as the source and destination IP addresses (operation 414). The host can encapsulate the packet with the encapsulation header to generate an encapsulated packet (operation 416) and send the encapsulated packet to the target host via a corresponding tunnel (e.g., tunnel 206 in FIG. 2B) (operation 418).

### Exemplary Computer System and Apparatus

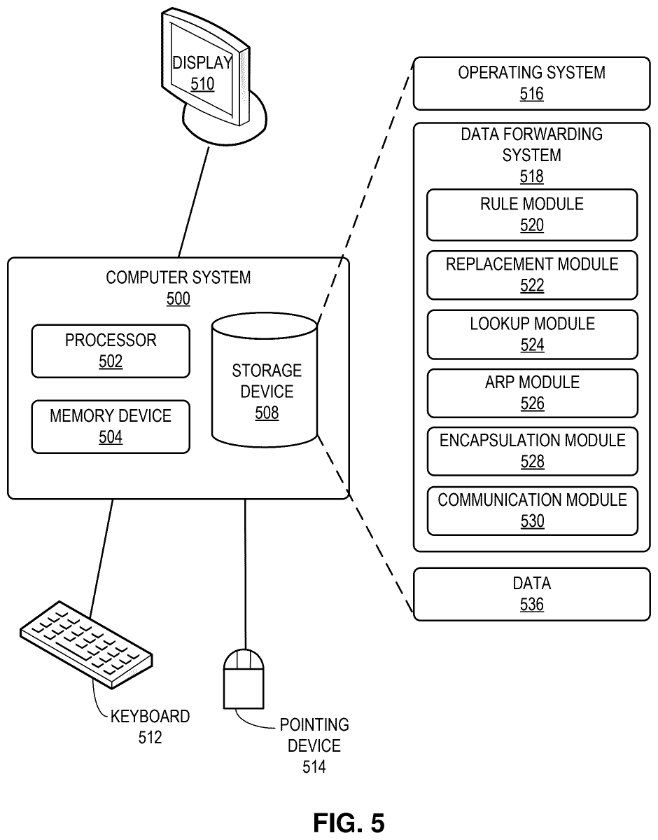

FIG. 5 illustrates an exemplary computer system that facilitates efficient traffic forwarding to and from a private cloud, in accordance with an embodiment of the present application. Computer system 500 includes a processor 502, a memory 504, and a storage device 508. Memory 504 can include a volatile memory (e.g., a dual in-line memory module (DIMM)). Furthermore, computer system 500 can be coupled to a display device 510, a keyboard 512, and a pointing device 514. Computer system 500 can operate as a host in a private cloud (e.g., hosts 112, 114, or 116 in FIG. 1A). Storage device 508 can store an operating system 516, a data forwarding system 518, and data 536.

Data forwarding system 518 can include instructions, which when executed by computer system 500, can cause computer system 500 to perform methods and/or processes described in this disclosure. Specifically, data forwarding system 518 can include instructions for determining a cloud MAC address as a source MAC of a packet and matching it to an address replacement rule (rule module 520). Data forwarding system 518 can also include instructions for replacing the source MAC address with the physical MAC address of an interface of computer system 500 (replacement module 522). Furthermore, data forwarding system 518 can include instructions for looking up the destination IP address of an incoming packet to determine a corresponding route (lookup module 524).

Moreover, data forwarding system 518 includes instructions for sending an ARP request for a target IP address in the route to determine the corresponding MAC address (ARP module 526). Data forwarding system 518 can also include instructions for encapsulating the packet with a tunnel encapsulation header for forwarding the packet via a tunnel (encapsulation module 528). Data forwarding system 518 can also include instructions for sending and receiving layer-2 and/or layer-3 packets (communication module 530).

Data 536 can include any data that is required as input or that is generated as output by the methods and/or processes described in this disclosure. Specifically, data 536 can store at least: flow rules received from an SDN controller, MAC and IP addresses of the VMs of a private cloud, subnet information of the private cloud, routes, and direct routes.

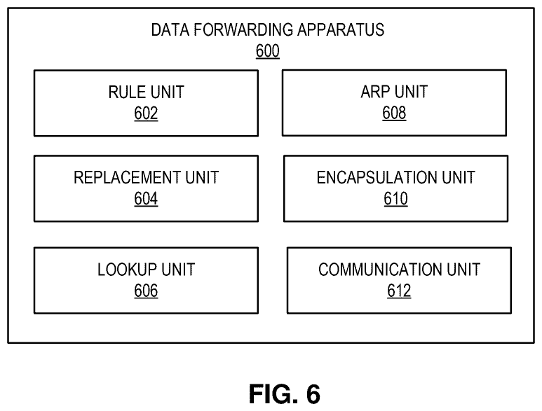

FIG. 6 illustrates an exemplary apparatus that facilitates efficient traffic forwarding to and from a private cloud, in accordance with an embodiment of the present application. Apparatus 600 may be realized using one or more integrated circuits, and may include fewer or more units or apparatuses than those shown in FIG. 6. Further, apparatus 600 may be integrated in a computer system, or realized as a separate device which is capable of communicating with other computer systems and/or devices. Apparatus 600 may also be a virtual device (e.g., a VM, a hypervisor, etc.).

Specifically, apparatus 600 can comprise units 602-612, which perform functions or operations similar to modules 520-530 of computer system 500 of FIG. 5, including: a rule unit 602; a replacement unit 604; a lookup unit 606; an ARP unit 608; an encapsulation unit 610; and a communication unit 612.

Note that the above-mentioned modules can be implemented in hardware as well as in software. In one embodiment, these modules can be embodied in computer-executable instructions stored in a memory which is coupled to one or more processors in computer system 500 and/or apparatus 600. When executed, these instructions cause the processor(s) to perform the aforementioned functions.

In summary, embodiments of the present invention provide a host in a private cloud. The private cloud can include one or more hosts running a set of VMs and appear as a logical router to an EGR coupling the private cloud. During operation, the host can receive a first packet from a VM running on the host. The host can determine that a source media access control (MAC) address of the first packet from the VM includes a virtual MAC address associated with the logical router. The host can replace, based on an address replacement rule programmed at the host. Here, the virtual MAC address with a physical MAC address of a local interface of the host as the source MAC address of the first packet. The host can determine the local interface as an egress interface for forwarding the first packet to the EGR.

The methods and processes described herein can be embodied as code and/or data, which can be stored in a non-transitory computer-readable storage medium. When a computer system reads and executes the code and/or data stored on the non-transitory computer-readable storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
identifying, by a host of a private cloud, a first packet from a virtual machine (VM) running on the host, wherein the private cloud includes one or more hosts running a set of VMs and appears as a logical router to an external router outside of the private cloud;
determining that a source media access control (MAC) address of the first packet from the VM includes a virtual MAC address associated with the logical router;
replacing, based on an address replacement rule programmed at the host, the virtual MAC address with a physical MAC address of a local interface of the host as the source MAC address of the first packet; and
determining the local interface as an egress interface for forwarding the first packet to the external router.

2. The method of claim 1, wherein the local interface of the host is coupled to the external router and is associated with the virtual MAC address.

3. The method of claim 1, wherein the virtual MAC address is associated with a respective host of the private cloud, and wherein the address replacement rule is programmed on a respective host of the private cloud.

4. The method of claim 1, further comprising:
generating, at a local instance of the logical router on the host, a layer-2 header for the first packet; and
setting the virtual MAC address as the source MAC address in the layer-2 header.

5. The method of claim 4, wherein the address replacement rule is programmed outside of the local instance of the logical router at the host.

6. The method of claim 1, further comprising:
receiving, by the host, a flow rule from a network controller provisioning the private cloud, wherein a respective flow rule indicates how traffic is to be processed at the host; and
determining the local interface as an egress interface based on the flow rule.

7. The method of claim 1, further comprising:
receiving, at the local interface from the external router, a second packet based on a direct route for an IP address of the VM;
replacing, based on a reverse address replacement rule programmed at the host, the physical MAC address of the local interface with the virtual MAC address as a destination MAC address of the second packet; and
forwarding the second packet to the logical router for providing the second packet to the VM.

8. The method of claim 1, further comprising storing information indicating a second host that hosts a second VM.

9. The method of claim 8, further comprising:
receiving, by the host, a third packet from the external router;
determining that the third packet is destined to second VM; and
encapsulating the third packet with a tunnel encapsulation header associated with a tunnel between the host and the second host.

10. A computer system, comprising:
a processor; and
a memory coupled to the processor and storing instructions, which when executed by the processor cause the processor to perform a method, the method comprising:
identifying a first packet from a virtual machine (VM) running on the computer system, wherein the computer system is in a private cloud, which comprises one or more computer systems running a set of VMs and appears as a logical router to an external router outside of the private cloud;
determining that a source media access control (MAC) address of the first packet from the VM includes a virtual MAC address associated with the logical router;
replacing, based on an address replacement rule programmed at the computer system, the virtual MAC address with a physical MAC address of a local interface of the computer system as the source MAC address of the first packet; and
determining the local interface as an egress interface for forwarding the first packet to the external router.

11. The computer system of claim 10, wherein the local interface of the computer system is coupled to the external router and is associated with the virtual MAC address.

12. The computer system of claim 10, wherein the virtual MAC address is associated with a respective computer system of the private cloud, and wherein the address replacement rule is programmed on a respective computer system of the private cloud.

13. The computer system of claim 10, wherein the method further comprises:
generating, at a local instance of the logical router on the computer system, a layer-2 header for the first packet; and
setting the virtual MAC address as the source MAC address in the layer-2 header.

14. The computer system of claim 13, wherein the address replacement rule is programmed outside of the local instance of the logical router at the computer system.

15. The computer system of claim 10, wherein the method further comprises:
receiving, by the computer system, a flow rule from a network controller provisioning the private cloud, wherein a respective flow rule indicates how traffic is to be processed at the computer system; and
determining the local interface as an egress interface based on the flow rule.

16. The computer system of claim 10, wherein the method further comprises:
receiving, at the local interface from the external router, a second packet based on a direct route for an IP address of the VM;
replacing, based on a reverse address replacement rule programmed at the host, the physical MAC address of the local interface with the virtual MAC address as a destination MAC address of the second packet; and
forwarding the second packet to the logical router for providing the second packet to the VM.

17. The computer system of claim 10, wherein the method further comprises:
storing information indicating a second computer system that hosts a second VM;
receiving, by the computer system, a third packet from the external router;
determining that the third packet is destined to second VM; and
encapsulating the third packet with a tunnel encapsulation header associated with a tunnel between the computer system and the second computer system.

18. A method, comprising:
identifying, by a router, a packet destined to a virtual machine (VM) reachable via a logical device, wherein the logical device corresponds to a private cloud comprising one or more hosts running a set of VMs;
looking up, in a forwarding data structure, a destination IP address of the packet to a route programmed on the router;
determining, from the route, a target IP address associated with the VM; and
determining a local interface of the router as an egress interface for forwarding the first packet to an external router outside of the private cloud.

19. The method of claim 18, wherein the route includes a direct route for the destination IP address, and wherein the target IP address is allocated to a host running a VM associated with the destination IP address.

20. The method of claim 18, wherein the route is for a subnet associated with the destination IP address, and wherein the target IP address is allocated to a host storing information location information of a VM associated with the destination IP address.
